(19) United States
(12) Patent Application Publication
(10) Pub. No.: US 2021/0056512 A1
(43) Pub. Date: Feb. 25, 2021

(54) SYSTEMS AND METHODS FOR DYNAMICALLY CLONING A TARGET USING BEHAVIORAL INSIGHTS

(71) Applicants: Raghavendra Misra, Ponte Vedra, FL (US); Rohan Misra, Ponte Vedra, FL (US)

(72) Inventors: Raghavendra Misra, Ponte Vedra, FL (US); Rohan Misra, Ponte Vedra, FL (US)

(21) Appl. No.: 17/000,234

(22) Filed: Aug. 21, 2020

Related U.S. Application Data
(60) Provisional application No. 62/890,526, filed on Aug. 22, 2019.
(60) Provisional application No. 62/890,546, filed on Aug. 22, 2019.

(51) Int. Cl. G06Q 10/10; G06Q 10/06; G06F 16/9035

(52) U.S. Cl. CPC G06Q 10/1053; G06F 16/9035; G06Q 10/06398; G06Q 10/06395

(57) ABSTRACT

What is needed is a system and method for using behavioral insights to determine who might be an appropriate placement or replacement within an organization. Accordingly, the present disclosure provides a more effective way to replace positions and teams. In some embodiments, the system may create a target candidate and pull from a pool of candidates to determine best fit using behavioral insights. In some implementations, the system may suggest a candidate based on an employer's requests. For example, an employer may specify they are looking for a candidate just like the one retiring. Based on the retiree, the system may find a viable candidate and present the person to the employer weighing what matches and what does not.

### CROSS-REFERENCE TO RELATED APPLICATION

This application claims priority to and the full benefit of U.S. Provisional Patent Application Ser. No. 62/890,526, filed Aug. 22, 2019, and titled “SYSTEMS AND METHODS FOR DYNAMICALLY PROVIDING AND DEVELOPING BEHAVIORAL INSIGHTS FOR INDIVIDUALS AND GROUPS” and U.S. Provisional Patent Application Ser. No. 62/890,546, filed Aug. 22, 2019, and titled “SYSTEMS AND METHODS FOR DYNAMICALLY CLONING A TARGET USING BEHAVIORAL INSIGHTS”, the entire contents of which are incorporated in this application by reference

### BACKGROUND OF THE DISCLOSURE

Replacing or recruiting an employee has been an issue for as long as an employer has needed a workforce. This was, and continues to be, a normal part of the employee life cycle, which traditionally included joining an organization, achieving promotions, and ultimately retiring from the organization. Human resources professionals regularly report having issues properly filling positions, whether that be from finding the candidates themselves or being able to find a good fit for the organization.

This expected employee life cycle has changed significantly with each generation, where mobility, opportunity, or culture were different. For example, baby boomers were more likely to work at one place for a majority of their lifetime, which brought an expectation of stability and retirement. For contrast, millennials seek employment upward mobility by seeking opportunities at other organizations typically within 3 years of working with an employer. Though employers work to anticipate the needs of each generation that work with them, employers still try to ensure some consistency within their organizations. Whether it be due to retirement, need for expansion, or replacing an employee that gives notice that they are leaving, employers always need to be ready to hire someone to keep the organization functioning without noticeable interruption or a dip in quality.

As a result, employers are on a perennial search for the right fit for their enterprise. Recruitment is a cornerstone of many organizations, so much so that recruitment has become its own industry with firms dedicated to helping organizations find candidates. Software has also been developed to help fill the void, streamline the process, and lower the cost for employers constantly looking for a replacement.

In the case of succession or promotions, employers may want to search from within when determining who might be a good fit to take over a role. Leveraging a known quantity, such as a promising employee, may be a low-cost solution before using recruitment services. Since every individual has their own strengths and weaknesses however, this is not as straightforward as an employer might want this process to be.

### SUMMARY OF THE DISCLOSURE

What is needed is a system and method for using behavioral insights to determine who might be an appropriate placement or replacement within an organization. Accordingly, the present disclosure provides a more effective way to replace positions and teams. In some embodiments, the system may create a target candidate and pull from a pool of candidates to determine best fit using behavioral insights. In some implementations, the system may suggest a candidate based on an employer's requests. For example, an employer may specify they are looking for a candidate just like the one retiring. Based on the retiree, the system may find a viable candidate and present the person to the employer weighing what matches and what does not.

In some embodiments, a system of one or more computers may be configured to perform particular operations or actions by virtue of having software, firmware, hardware, or a combination of them installed on the system that in operation causes or cause the system to perform the actions. In some implementations, one or more computer programs may be configured to perform particular operations or actions by virtue of including instructions that, when executed by data processing apparatus, cause the apparatus to perform the actions. In some aspects, the cloning method may comprise receiving a first target to clone; accessing a target behavioral insight profile database may comprise a plurality of behavioral profiles, wherein each of the plurality of target behavioral insight profiles provides behavioral insights for each target; identifying a first behavioral insight profile; presenting the target behavioral insights; generating a clone behavioral insight profile based on the target behavioral insight profile; accessing a candidate profile database may comprise a plurality of candidate behavioral insight profiles, wherein each of the plurality of target behavioral insight profiles provides behavioral insights for each candidate; comparing clone behavioral insight profile to the plurality of candidate behavioral insight profiles; identifying at least a portion of the plurality of candidate behavioral insight profiles that are similar to the clone behavioral insight profile, wherein similarity is based on predefined parameters; presenting at least the portion of the plurality of candidate behavioral insight profiles. In some embodiments, this may include corresponding computer systems, apparatus, and computer programs recorded on one or more computer storage devices, each configured to perform the actions of the methods.

In some implementations, the target behavioral insight profile is manually configurable. In some aspects, the cloning method may comprise generating a job description based on the target behavioral insight profile. In some embodiments, the cloning method may comprise receiving a job description. In some aspects, analyzing determines a level of effectiveness of the clone behavioral profile based on the job description. In some implementations, suggested changes increase the level of effectiveness based on the job description. In some aspects, each of the plurality of target behavioral insight profiles and each the plurality of candidate behavioral insight profiles may comprise behavioral insights for a plurality of qualities. In some embodiments, each of the plurality of qualities is assigned a weighted score based on predefined parameters. In some implementations, similarity is based at least in part on a comparison of weighted scores of the plurality of qualities. In some aspects, the weighted score is manually adjustable. In some embodiments, the weighted score is based on relevance of each of the plurality of qualities to effectiveness. In some implementations, the target behavioral insight profile database and the candidate profile database are the same. In some embodiments, described techniques may include hardware, a method or process, or computer software on a computer-accessible medium.

In some aspects, the present disclosure may comprise a method of cloning a team based on behavioral insights. In some embodiments, the method of cloning may comprise receiving a target team profile which may comprise a target set of behavioral insights for a plurality of qualities; generating a clone behavioral insight profile based on the target team profile; accessing a candidate profile database may comprise a plurality of candidate behavioral insight profiles, wherein each of the plurality of target behavioral insight profiles provides behavioral insights for each candidate; comparing clone behavioral insight profile to the plurality of candidate behavioral insight profiles; generating at least one cloned team may comprise a first set of candidates, wherein collection of candidate profiles for the first set candidates is similar to the clone behavioral insight profile, and wherein similarity is based on a comparison of behavioral insight values for the plurality of qualities. In some aspects, this may include corresponding computer systems, apparatus, and computer programs recorded on one or more computer storage devices, each configured to perform the actions of the methods.

In some implementations, one or more of the following features of the cloning method may comprise analyzing the target team profile, wherein analyzing determines a level of effectiveness of the target team. In some aspects, suggested changes increase the level of effectiveness of the target team. In some embodiments, each of the plurality of qualities is assigned a weighted score based on predefined parameters. In some aspects, similarity is based at least on the weighted score of each of the predefined parameters. In some implementations, analyzing determines a level of effectiveness of the target team. In some aspects, suggested changes increase the level of effectiveness of the target team. In some implementations of the described techniques may include hardware, a method or process, or computer software on a computer-accessible medium.

In some aspects, the present disclosure may comprise a method of cloning a team based on behavioral insights. In some embodiments, the method of cloning may comprise receiving a plurality of members; accessing a member profile database may comprise a plurality of member behavioral insight profiles, wherein each of the plurality of member behavioral insight profiles provides behavioral insights for each member; retrieving behavioral insight profiles for each of the plurality of members; generating a target team profile may comprise a target set of behavioral insights for a plurality of qualities, wherein the target team profile is based on predefined parameters. In some aspects, this may include corresponding computer systems, apparatus, and computer programs recorded on one or more computer storage devices, each configured to perform the actions of the methods.

### BRIEF DESCRIPTION OF THE DRAWINGS

The accompanying drawings, that are incorporated in and constitute a part of this specification, illustrate several embodiments of the disclosure and, together with the description, serve to explain the principles of the disclosure:

FIG. 1 illustrates an exemplary clone dashboard, according to some embodiments of the present disclosure.

FIG. 2 illustrates an exemplary team clone dashboard, according to some embodiments of the present disclosure.

FIG. 3A illustrates exemplary team clone dashboard with behavioral insights, according to some embodiments of the present disclosure.

FIG. 3B illustrates exemplary team dashboard with illustrated behavioral insights, according to some embodiments of the present disclosure.

FIG. 3C illustrates exemplary team dashboard with text behavioral insights, according to some embodiments of the present disclosure.

FIG. 4 illustrates an exemplary individual behavioral insight dashboard, according to some embodiments of the present disclosure.

FIG. 5 illustrates an exemplary team behavioral insight dashboard, according to some embodiments of the present disclosure.

FIG. 6 illustrates an exemplary team behavioral insight dashboard, according to some embodiments of the present disclosure.

FIG. 7 illustrates exemplary calendar system flow, according to some embodiments of the present disclosure.

FIG. 8 illustrates exemplary data flow for a behavioral insight system, according to some embodiments of the present disclosure.

FIG. 9 illustrates exemplary data flow for a cloning system and processes, according to some embodiments of the present disclosure.

FIG. 10 illustrates exemplary behavioral insights and meeting strategy suggestions, according to some embodiments of the present disclosure.

FIG. 11 illustrates exemplary distribution of behavioral insights within an organization, according to some embodiments of the present disclosure.

FIG. 12 illustrates exemplary method steps for cloning a target, according to some embodiments of the present disclosure.

FIG. 13 illustrates exemplary method steps for developing behavioral insights, according to some embodiments of the present disclosure.

FIG. 14 illustrates exemplary method steps for tracking performance in context of behavioral insights, according to some embodiments of the present disclosure.

FIG. 15 illustrates an exemplary method steps for cloning behavioral insight profiles, according to some embodiments of the present disclosure.

FIG. 16 illustrates an exemplary method steps for providing a cloned team, according to some embodiments of the present disclosure.

FIG. 17 illustrates an exemplary block diagram of an exemplary embodiment of a mobile device.

FIG. 18 illustrates an exemplary processing and interface system.

### DETAILED DESCRIPTION

What is needed is a system and method for using behavioral insights to determine who might be an appropriate placement or replacement within an organization. Accordingly, the present disclosure provides a more effective way to replace positions and teams. In some embodiments, the system may create a target candidate and pull from a pool of candidates to determine best fit using behavioral insights. In some implementations, the system may suggest a candidate based on an employer's requests. For example, an employer may specify they are looking for a candidate just like the one retiring. Based on the retiree, the system may find a viable candidate and present the person to the employer weighing what matches and what does not.

In the following sections, detailed descriptions of examples and methods of the disclosure will be given. The description of both preferred and alternative examples, though thorough, are exemplary only, and it is understood that to those skilled in the art variations, modifications, and alterations may be apparent. It is therefore to be understood that the examples do not limit the broadness of the aspects of the underlying disclosure as defined by the claims.

### Glossary

Behavioral Insight: as used herein refers to characteristics and attributes associated with a person, persons, or groups. In some embodiments, the characteristics and attributes may be a combination of psychometric profile, interests, talents, and skills, as non-limiting examples. In some aspects, behavioral insights may consider performance data, feedback data, historical data, user-generated data, or combinations thereof. In some aspects, the behavioral insight may be applied to business roles, personal roles, academic roles, or any other role where understanding behavior may be useful. For example, a life coach may use behavioral insights to inform how to coach a user. As another example, an employer may use behavioral insights to understand and improve team dynamics.
Candidate Pool: as used herein refers to a segment of individuals or groups who may be available and identifiable through the cloning system. In some aspects, the candidate pool may be organization-specific, such as where an organization prefers to hire within its existing employees. In some embodiments, a candidate pool may be limited to those with accessible psychometric profiles. In some aspects, a candidate pool may be created through interfacing with a networking or employment platform, wherein candidates may input or provide access to their personal details. In some embodiments, a candidate pool may comprise applicants to a position.
Clone: as used herein refers to a person or group with a similar psychometric makeup as a target. Used as a verb, the process of cloning may allow for identification and development of like persons or groups in comparison to target criteria. For example, group A may comprise three personality types, and group B may comprise the same three personality types. Group A may be a clone of group B. As another example, person A may be set as the target criteria, wherein cloning person A may identify other persons with a similar psychometric makeup. Clones or cloning may be useful when assembling teams where an effective psychometric makeup is known and target criteria may be defined, such as by historical data or based on the success of an identified group. Clones or cloning may be useful when a person may need to be replaced, such as when an effective employee may leave the company or move to a different team or position.
Meeting: as used herein refers to any event with attendees and a host. For example, a meeting may comprise a group of employees from a company, wherein the meeting may be hosted by a manager. As another example, a meeting may comprise a speaking engagement or conference.
Psychometric Profile: as used herein refers to a set of psychometric attributes associated with a person, persons, or groups based on actual psychometric assessments, historical psychometric assessments associated with a demographic, implied psychometric attributes based on behavior, or combinations thereof.
Subject: as used herein refers to a person or group who is the subject of a psychometric profile, behavioral insights, feedback, or performance data, as non-limiting examples.
Target: as used herein refers to a person, group, archetype or other basis for a psychometric profile. In some aspects, the target may be base for a clone, wherein the clone may comprise a similar psychometric profile as the target. In some embodiments, the target may be an identified person, such as an employee about to leave a company; an identified team, such as a development team that effectively and efficiently developed a sophisticated program; or an archetype whose historical or predicted statistics suggest that its psychometric profile may produce a successful clone, as non-limiting examples.

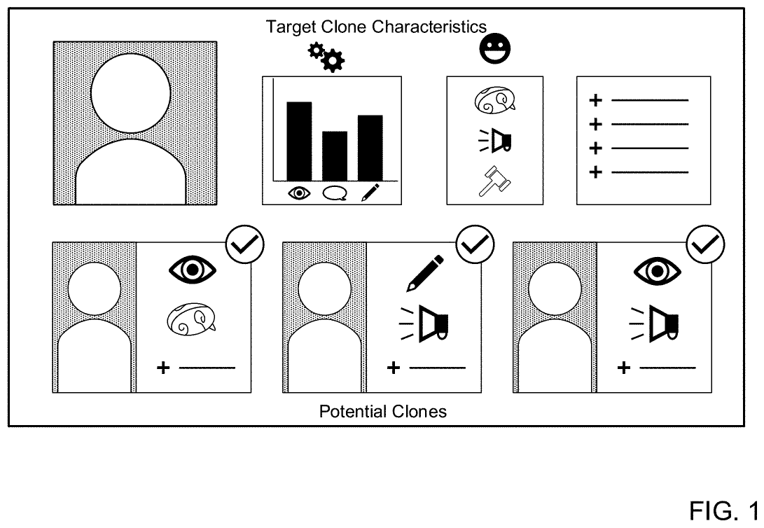

Referring now to FIG. 1, an exemplary clone dashboard is illustrated. In some aspects, there may be a known target to clone, such as an employee who is leaving the company, a successful research and development team, a successful c-suite, or position-specific archetypes. In some embodiments, the clone dashboard may allow for selection of a target whose psychometric profile is known, such as an employee or other individual who allows for access to their psychometric profile. In some aspects, the clone dashboard may allow for selection or may suggest psychometric profiles that may be associated with successful outcomes, such as through performance data, feedback data, or other success metrics.

In some embodiments, the clone dashboard may present success metric data in conjunction with the psychometric profile of the target. For example, the clone dashboard may present performance metrics and may correlate the quality of the performance with behavioral insights, which may inform what attributes positively affect their performance and what attributes may have negatively affected their performance. Understanding this connection, the clone dashboard may allow for an adjustment of the clone criteria, such as to decrease the presence of attributes that may negatively affect performance. As non-limiting examples, the performance metrics may comprise performance data, feedback data, engagement data, or other measurable metrics.

In some embodiments, the clone system may search a candidate pool for comparable psychometric profiles that may be suitable as clones, and the similar candidates may be presented. In some implementations, a candidate pool may comprise applicants, current employees, accessible profiles, such as through a third-party platform. In some aspects, the similar candidates may be presented with general attributes, which may include names, skills, experience, current position, or behavioral insights, as non-limiting examples.

In some implementations, the presentation may be customized, such as based on the clone position, preferences, or most significant attributes. For example, the ability to operate a particular piece of equipment may be a hard requirement for the position, and it may be helpful to confirm that qualification for each similar candidate. As another example, attributes related to leadership qualities may be more significant than the type of college degree or other experience. The most relevant attributes may be presented, which may be suggested by the clone dashboard or may be manually set.

In some embodiments, cloning through behavioral insights may be used in sports organizations to target specific players, positions, or talent gaps. The clone system may be able to identify certain characteristics the organization may be looking for; based on position, scheme fit, or player needs. The organization may be able to input known players, which may from the same organization allowing the system to generate a list of similar players. In some aspects, the known players may be from their own roster, such as a retired, graduated, injured, or traded player. In some embodiments, the known players may be from other teams, leagues, or sports. For example, a team may want to clone a historical player, or a professional team may want to clone a collegiate athlete.

In some aspects, the cloning system may also be able to identify the pros and cons of each athlete using a comparison tool. This may allow the sports organization to determine the most beneficial player for the team. In some aspects, the organization may be able to compare the players' statistics to one another, which may allow the organization to recognize its most desired skills or attributes.

For example, the organization may be a professional football team, and they may need to fill the tight end position. Their previous tight end may have been traded, and they know another unavailable tight end who may better fit their offensive strategy. The cloning system may compare other available tight ends to the target tight end. The cloning system may analyze collegiate athletes who may fit the clone characteristics, which may broaden the scope of the original search. Collegiate athletes may have more flexibility for their position than professional athletes, and the cloning system may compare the clone characteristics of athletes at any position and possibly other sports, such as baseball.

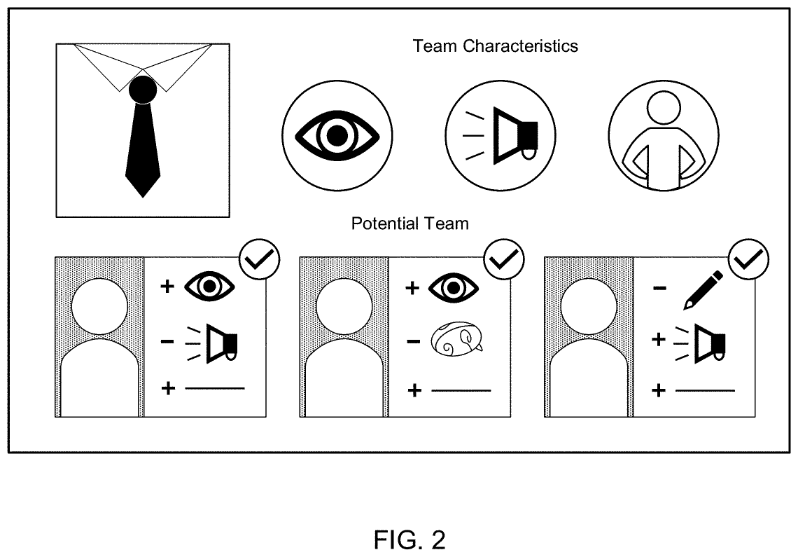

Referring now to FIG. 2, an exemplary clone dashboard is illustrated. In some aspects, a team may be constructed through a cloning process, wherein the clone characteristics for the team may be manually set. In some embodiments, the candidate pool for the team may be defined, such as any employee of the organization, any person not in a management role, or any person in a specific department or position, as non-limiting examples.

In some implementations, once the clone characteristics are set, the system may generate clone options from the candidate pool. In some aspects, various teams may be generated based on the clone characteristics, wherein the aggregated psychometric profiles of the teams may be similar to the clone characteristics. In some embodiments, the teams may comprise defined archetypes, such as an engager, alpha, community builder, or other classification, wherein the team options provide different combinations of those archetypes to achieve similar aggregated psychometric profiles.

In some implementations, the various teams may comprise specific individuals whose aggregated psychometric profiles may be similar to the clone characteristics. In some aspects, a user may be prompted to select a team archetype makeup, which may then prompt generation of teams of identified individuals. In some implementations, the clone characteristics may be populated based on known successes, such as the founders of a specific startup, or success trends, such as typical psychometric makeup of successful startups.

In some embodiments, the dashboard may be able to generate the best lineup for a sports team. For example, where a team is struggling and may benefit from a new strategy, a clone dashboard may generate a better lineup for the team based on the new strategy. In some aspects, the sports organization may be able to generate different lineups for different scenarios of different games. For example, the team may generate a lineup for the beginning of the game versus a scenario where it may be a close game toward the end.

In other aspects, the dashboard may display an effectiveness score based on the current lineup versus an alternate lineup generated by the system. In some embodiments, the system may be able to generate real-time lineups that may give the team a better chance of winning the game at the given moment in time. In some aspects, the sports organization may be able to determine which lineup to use based on the success/win percentage given by the dashboard.

In some implementations, a cloning system may help create cloned teams within a group. For example, a professor may want to break a class of eighty into groups of four, where each group may have a similar makeup. The professor may want to avoid stacking one group with type A personalities and another group without self-motivated people. Identifying target group clone characteristics may allow the professor to create similar groups. In some embodiments, the professor may have the behavioral insight profiles for her students, and the cloning system may identify group clone characteristics based on the known profiles of the students. In some aspects, group clone characteristics may be based on known effective group structures and then applied to the students in the class.

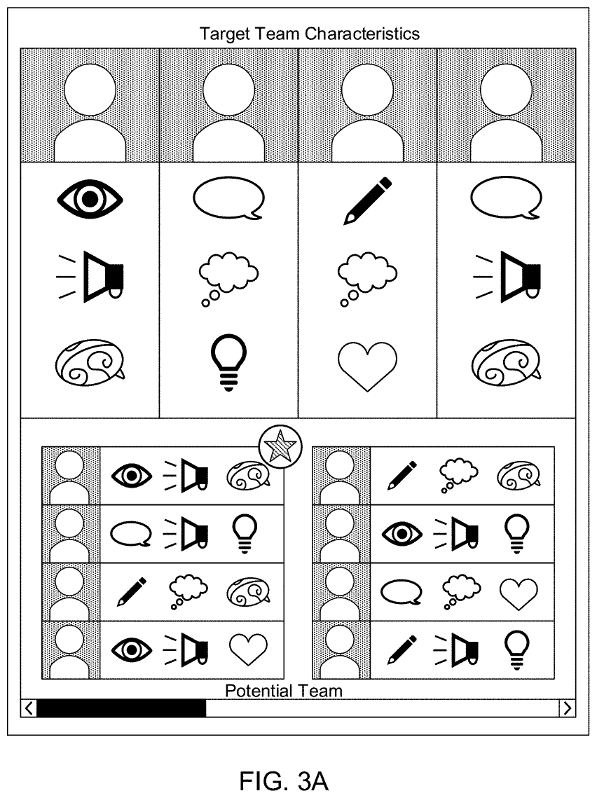

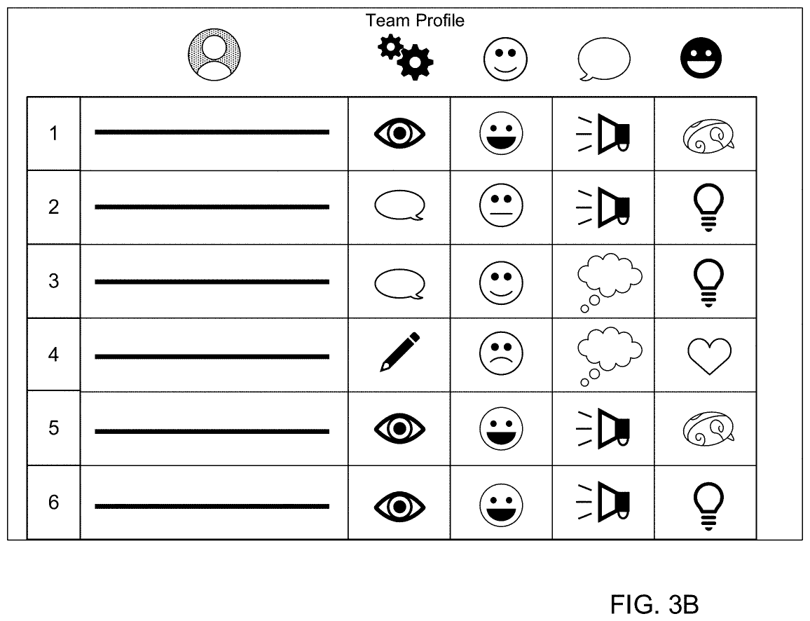

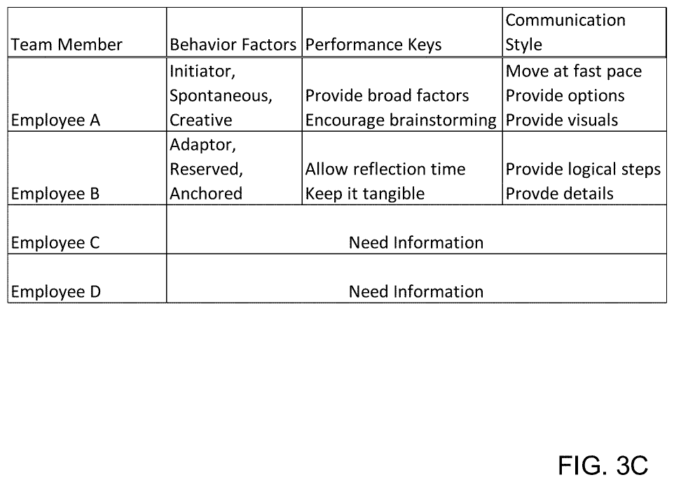

Referring now to FIG. 3A, an exemplary team clone dashboard with behavioral insights is illustrated. Referring now to FIG. 3B, exemplary team dashboard with illustrated behavioral insights is illustrated. Referring now to FIG. 3C, an exemplary team dashboard with text behavioral insights is illustrated.

In some aspects, the aggregated psychometric profiles and behavioral insights may be provided for a team. In some embodiments, a team may be manually selected or may be based on identified groups, such as by project, department, position, location, or performance types, as non-limiting examples. In some implementations, it may be useful to view the overall makeup of a team to understand how they can be successful. For example, knowing that a team is lacking any member with an attention to detail may prompt the company to add a detail-oriented person to the team who may also complement the other team attributes. As another example, knowing that a team is competitive in a productive manner may inform how projects are presented to them so as to encourage their competitive nature.

In some aspects, as team members may be added and removed, the aggregate behavioral insights may change to reflect the removed or added psychometric profiles. In some embodiments, this may occur in real time. This may allow for immediate behavioral insights based on adjustments to team dynamics. A team builder may utilize this feature to tailor a team to a specific goal. In some aspects, a team builder may utilize this feature to adjust a team to be more effective.

In some embodiments, the system may suggest ways to improve a team or may suggest team memberships. For example, based on behavioral insights, the system may suggest team building exercises that may increase camaraderie for one team, and the system may suggest adding in a detail-oriented member to a team that lacks that attribute. In some aspects, behavioral insights may allow a company to develop an effective team for a specific client, task, department, or role, as non-limiting examples.

In some aspects, the behavioral insight dashboard may be able to predict future behavioral problems from specific players a team may be looking at to better their organization. This may prevent sports organizations from enlisting incompatible players that may otherwise cause an imbalance within the team. In some embodiments, the behavioral insight dashboard may generate the best lineup for team chemistry. In some implementations, this may allow the organization to run smoother as a whole.

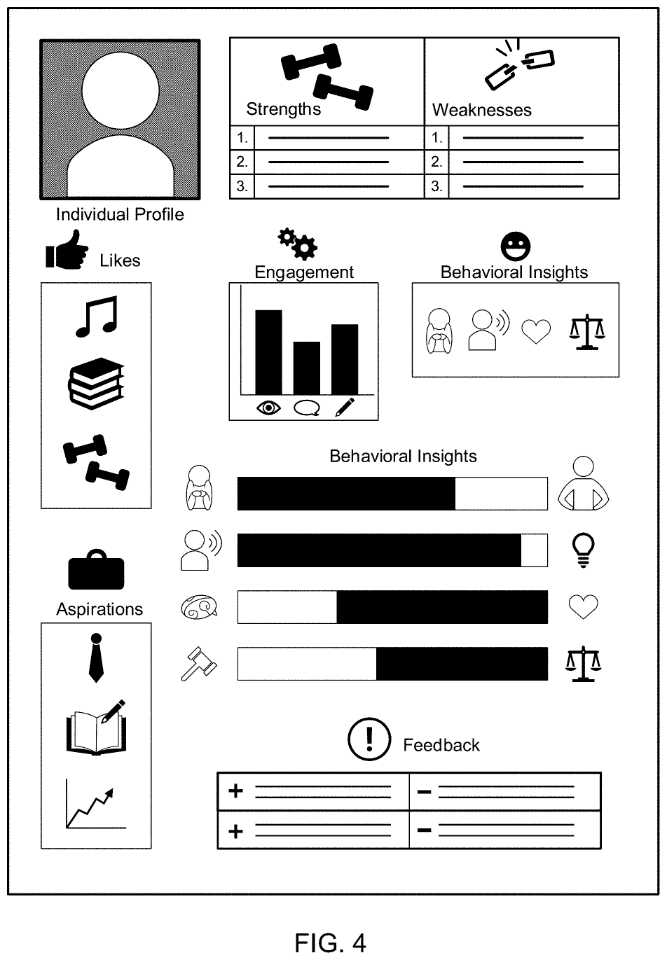

Referring now to FIG. 4, an exemplary behavioral insight dashboard is illustrated. In some embodiments, the behavioral insight dashboard may present behavioral insights in graphic form, which may include illustrations of potential psychometric profile permutations. In some aspects, the behavioral insight dashboard may provide a high level understanding of a workforce over time. In some implementations, understanding trends of the aggregated psychometric profiles of the workforce may be useful. In some aspects, the aggregated behavioral insights and psychometric profiles may be correlated and compared to other historical data, such as performance data, feedback data, customer reviews, valuations, sales, or employee turnover, as non-limiting examples.

In some aspects, a psychometric profile may be associated with an individual, which may be generated through a directed psychometric assessment, personal data, tracked activities, third-party feedback, training, education, experience, interests, or combinations thereof. In some implementations, a psychometric profile may be associated with a group, such as a team, workforce, c-suite, or position. In some embodiments, the group psychometric profile may comprise an aggregation, extrapolation, average, or other combination of the individual psychometric profiles.

In some implementations, scores for different attributes, such as team effectiveness scores, c-suite scores, leader scores, or position scores (for a specific position in a company), may be generated based, at least in part, on a psychometric profile. In some aspects, the psychometric profile may be combined with other data, such as performance data, feedback data, interests, aspirations, skills, or experience, as non-limiting examples.

In some embodiments, a real time assessment of the company climate may be generated, such as generally content, anxious, discontent, suspicious, trusting, or loyal, as non-limiting examples. In some aspects, the climate may be assessed by overall employees, team, position, or role, as non-limiting examples. In some implementations, suggestions on how to improve scores and climate may be provided based on the psychometric profiles and behavioral insights of the individuals and groups.

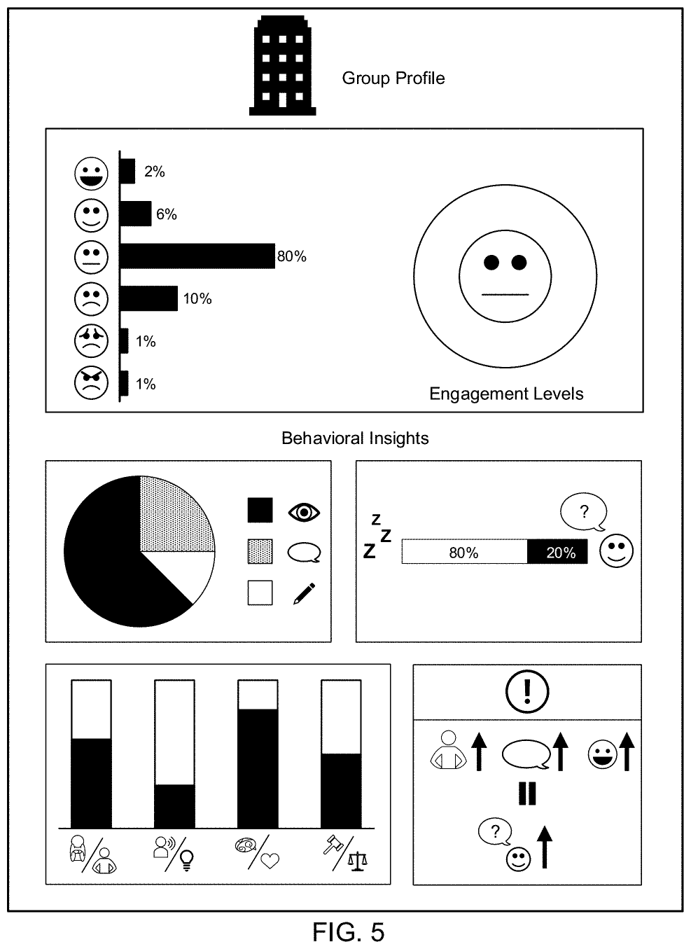

Referring now to FIG. 5, an exemplary behavioral insight dashboard is illustrated. In some aspects, the behavioral insight dashboard may provide an aggregated understanding of the workforce for a company. In some embodiments, the workforce may comprise employees, contractors, vendors, managers, third party service providers, or other groups or individuals that may impact the success of the company, as non-limiting examples.

For example, the behavioral insight dashboard may provide historical data in graph form tracking the level of engagement of the workforce. The level of engagement may correlate to the overall climate, wherein high engagement of the work force may indicate that the employees are content and excited to be part of the company. Low engagement may indicate that the employees are unhappy or uninterested in the company, which may suggest they are likely to leave when they find another company that may provide more satisfaction.

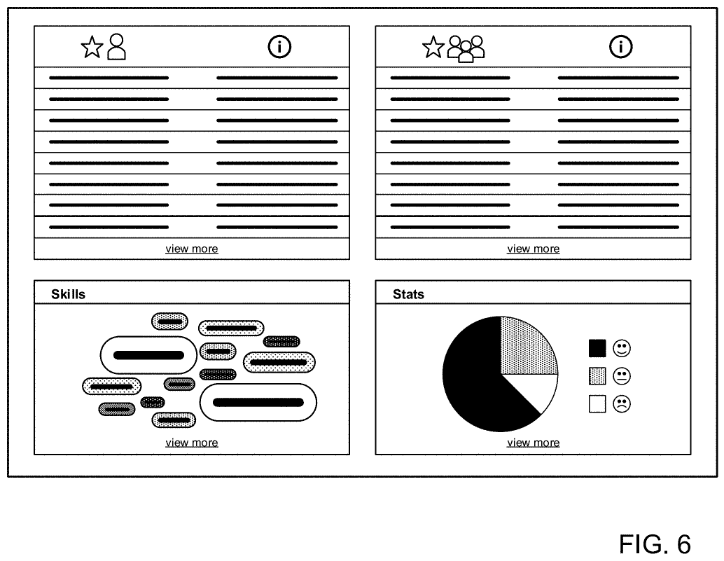

Referring now to FIG. 6, an exemplary behavioral insight dashboard is illustrated. In some embodiments, employees or team members may be ranked based on a variety of factors, which may be customized, such as by company, skill, department, or position, as non-limiting examples. In some aspects, the behavioral dashboard may allow for sorting and filtering, which may allow for viewing of highly-customized behavioral insights and psychometric profiles.

For example, a company may want to separately assess the behavioral insights for their java developers and their sales team. The relevant metrics for understanding their psychometric profiles and behavioral insights may be distinct. Engagement for java developers may comprise attending workshops and participation in projects, and engagement for a sales team may be visiting clients and attending client events. Accordingly, ranking employees in each department may be based on different factors and the most engaged or successful employee from each group may have very different psychometric profiles.

In some embodiments, the behavioral insight dashboard may rank players within a sports organization, which may integrate the player's general rank within the sport in addition to how well they match the clone characteristics. In some embodiments, the dashboard may have the ability to rank all players in all organizations in a specific sport, and this may enable specific organizations to target specific players for their organizations.

In other embodiments, the behavioral insight dashboard may have the ability to predict players' stats in specific organizations throughout the season. This may allow specific organizations to trade players to better their teams. For example, the dashboard may be able to predict a player's change in stats.

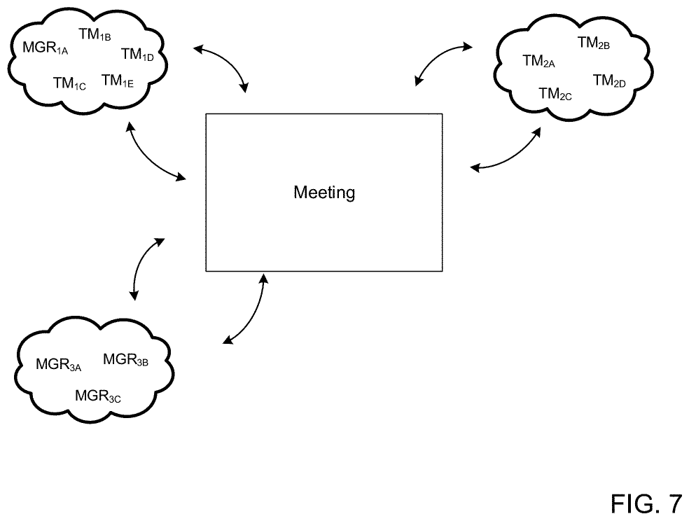

Referring now to FIG. 7, exemplary calendar system flow is illustrated. In some aspects, the system may suggest or guide the invitee list based on predefined criteria. In some aspects, the predefined criteria may include psychometric characteristics, individual roles within a team, team roles within the company, relevance of the roles to the topic of the meeting, or influence within the team or company, as non-limiting examples.

For example, the topic may be related to a new project, and the invitees may be those who need to execute the project. The topic may relate to company missions and culture, and the invitees may be those who have the most influence within the company. In some aspects, the system may allow a host to initiate a meeting. In some embodiments, the system may allow a host to set up a series of meetings that may accomplish similar action items or goals, wherein each set of invitees may comprise a similar aggregated psychometric profile.

As an illustrative example, a company-wide meeting about workers' compensation may be necessary but, according to regulation, each meeting can be no larger than ten people. The system may help divide up the workforce so that each set of invitees may be effective with a similar presentation and meeting strategy. Without behavioral insights, a host may create invitee sets with only type A personalities or without any type A personalities. It may be beneficial to balance out the group based on predefined criteria.

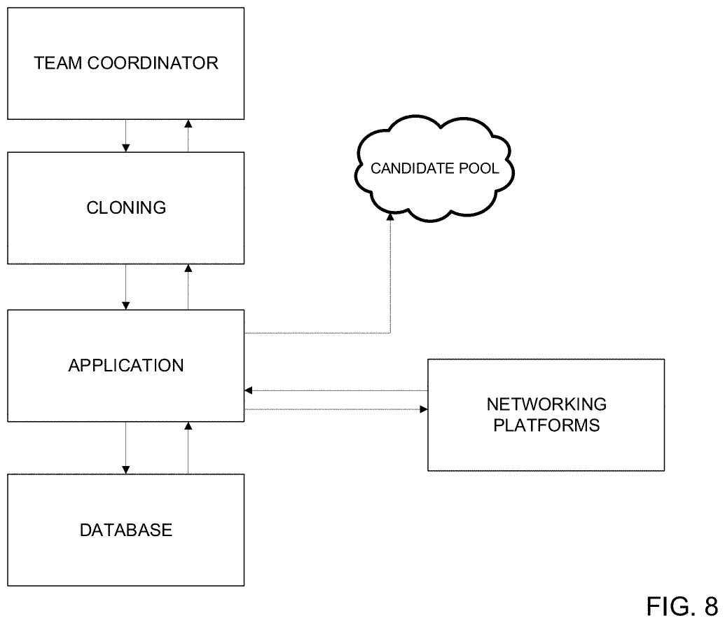

Referring now to FIG. 8, exemplary data flow for a behavioral insight system is illustrated. In some aspects, a team coordinator may input to the cloning system clone information, such as identifying the target, position details, and preferred attributes, as non-limiting examples.

In some embodiments, that information may be transmitted to the application, wherein the application may access the database to retrieve and process the psychometric profiles of the candidate pool, a list of similar candidates, and other relevant data that may help inform a cloning decision, such as those suggested by the application. For example, the other relevant data may comprise performance data, feedback data, and psychometric profile data of other similar targets.

In some aspects, the application may logically interface with a networking platform, which may be internal or external, wherein the application may transmit clone information, such as preferred attributes and position details, as non-limiting examples. In some embodiments, the networking platform may export a job posting to the application. In some implementations, the application may output information to the clone system, such as behavioral insights, performance data, and suggested similar candidates, as non-limiting examples. In some aspects, the behavioral insights and suggested similar candidates may be presented through graphics, charts, text, or combinations thereof. In some implementations, the list of similar candidates may be output from the application through the cloning system to the team coordinator. In some aspects, a job posting or offer may be transmitted to the similar candidates.

In some embodiments, psychometric profiles may not be known for all candidates. The application may still identify similar candidates within the group of candidates without psychometric profiles. The identification may occur through extrapolation of a psychometric profile through other accessible data, such as feedback data, performance data, experience, aspirations, or interests, as non-limiting examples. In some aspects, a team coordinator may indicate that specific skills and experience may be the most significant attributes for a position, and a similar candidate may match those attributes. The application may then transmit a request to the similar candidate to create a psychometric profile. Once received, the similar candidate may be compared to the clone.

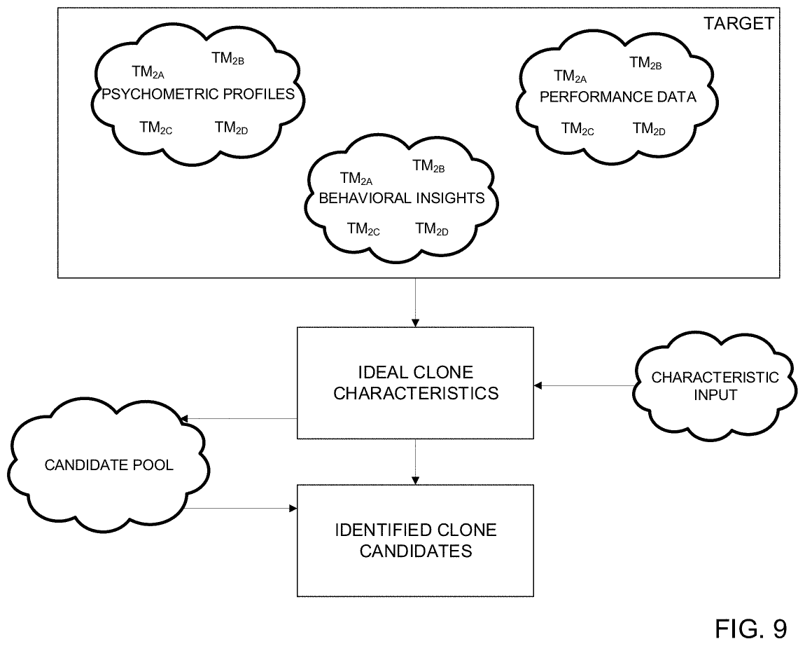

Referring now to FIG. 9, exemplary data flow for a cloning system and processes is illustrated. In some aspects, a target may be identified to clone, wherein psychometric profiles, behavioral insights, performance data, or combinations thereof may be available for the target. In some embodiments, the target may comprise an individual or a group. For example, a highly regarded and effective manager may be promoted to another position, and the organization may want to replace her with someone very similar, which may allow for a seamless transition and continued productivity. The manager may be the target to clone, wherein her replacement may have a similar psychometric profile.

In some embodiments, the psychometric profiles and behavioral insights may be compared and correlated to performance data, which may allow for identification of characteristics that likely increase effectiveness and areas where performance may be improved. Incorporating performance data may allow for informed input to adjust the clone characteristics to include the effective portions and adjust the ineffective portions of the psychometric profile. In some aspects, based on the set clone characteristics, the system may search the candidate pool and identify candidates with a similar psychometric profile.

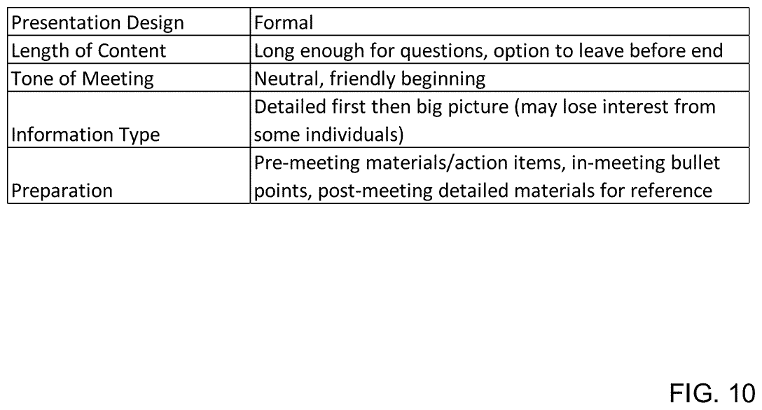

Referring now to FIG. 10, exemplary behavioral insights and meeting strategy suggestions are illustrated. In some aspects, a summary of behavioral insights for invitees may be provided, which may allow the host to prepare based on the summary. In some embodiments, the summary may be paired with more detailed behavioral insights. In some implementations, the summary may be based on the percent of invitees with particular psychometric profile attributes, wherein the summary indicates behavioral insights for the majority of the invitees.

In some embodiments, the summary may be based on the most sensitive psychometric profile attributes. For example, eight out of ten invitees may benefit from a big picture presentation, and two out of ten invitees could not be effective without the details. Those eight out of ten may not be negatively impacted by the details, so the summary may suggest the presentation of details. A system providing a dynamic summary of behavioral insights may process the psychometric profiles of each invitee and weigh their attributes and behavioral insights, wherein the summary may provide group behavioral insights and suggested meeting strategies based on weighted assessments.

In some aspects, the summary may evolve as invitees either accept or decline attendance. This may allow for dynamic behavioral insight that updates as the invitee list changes. For example, if all the invitees who need time for questions decline the invitation, the host may remove that portion of the meeting. In some embodiments, the summary may provide suggestions on meeting details, such as the best time of day to conduct the meeting or the most effective location. For example, the invitees who need more details may benefit from a morning meeting with food, which may give them the rest of the day to process the contents of the meeting and sustenance to last through a long meeting. As another example, where invitees may have a hectic schedule and only need a quick overview, the meeting may be held in the break room as a standing huddle.

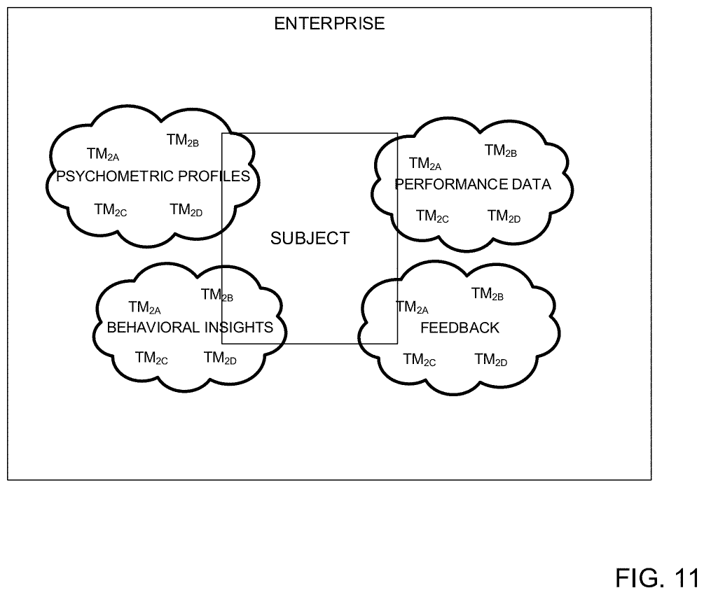

Referring now to FIG. 11, exemplary distribution of behavioral insights within an organization is illustrated. In some embodiments, an organization may maintain databases with psychometric profiles, performance data, behavioral insights, and feedback. In some aspects, these databases may be maintained in groups or separately. In some implementations, the databases may be organized or categorized by subject, such as by person, team, or position, as non-limiting examples. In some aspects, the databases may be logically linked, which may allow for correlation between the data, such as by subject.

For example, the subject may comprise an individual, and her psychometric profile and behavioral insights may be compared to her performance and feedback. This may allow for an assessment of whether she is performing above or below expectations based on her behavioral insights. In some aspects, her performance may be compared to her feedback, which may provide insight as to how effective the feedback has been and whether her responses have been in line with expectations or predictions based on her psychometric profile and behavioral insight.

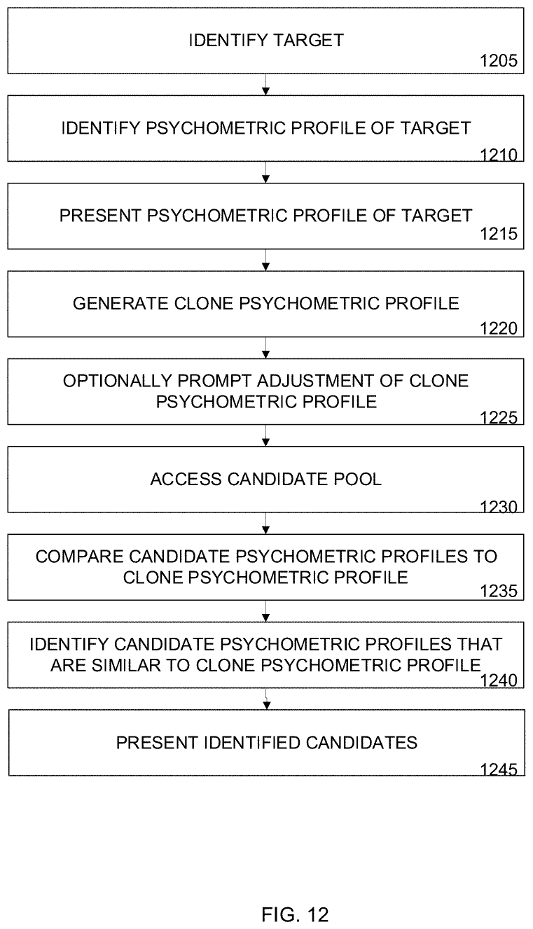

Referring now to FIG. 12, exemplary method steps for cloning a target are illustrated. At 1205, a target may be identified, such as by identifying a specific person or group or be identifying a person or group archetype with known success rates. At 1210, a psychometric profile of the target may be identified, such as through accessing a psychometric profile database.

In some aspects, the target may be manually identified, such as when an employee is leaving the company or changing position. In some embodiments, the target may be suggested based on the purpose or position of the clone. For example, the cloning may be to create an effective c-suite for a video game company. Referring to c-suites of similar industries, the system may process or may receive processed historical performance data, feedback data, behavioral insights, psychometric profile data, or combinations thereof, as non-limiting examples. Based on the historical data, an effective aggregated psychometric profile may be identified as the target. The target may be an extrapolated effective makeup or may be the actual makeup for a successful team.

In some embodiments, cloning may allow for an individual to translate their skills and experience into a universal profile, which may allow for transitions in career, such as between jobs, after incarceration, after graduation, between public and private sector, as non-limiting examples. For example, a person may be transitioning from a military to civilian life, where a civilian role parallel to the military may not exist. In some aspects, an individual may develop their behavioral insight profile into a job description that their profile may fit, which may be used to identify compatibility with actual professional roles. In some embodiments, potential employers or team leaders may be able to find compatible team members who may not have a traditional resume.

As an illustrative example, an individual may be looking for employment and may have administrative experience that they acquired during incarceration, which typically does not equate to a direct resume point. The system may develop or receive a behavioral profile of the individual, which may incorporate the practical experience with aspirations, psychometric profile data, skills, and talents. The individual may search for roles where their behavioral profile would be effective. A sample job description may be generated based on the individual's behavioral profile, which may allow for an effective search.

As another illustrative example, a college may be searching for student candidates for their new engineering school. The college may identify specific students who exemplify successful graduates in their other schools, such as for nursing or literature. A clone behavioral insight profile may be developed based on those graduates. Those behavioral insight profiles may be compared to behavioral insight profiles of successful engineering students from other educational institutes. The clone behavioral insight profile may be adjusted to reflect some of the attributes from other educational institutes. From there, the college may have access to a graduating student body, which may include behavioral insight profiles of graduating high school students within a predefined area. The college may identify high school students with behavioral insight profiles that are similar to the clone behavioral insight profile. Once identified, the college may directly reach out to the students, such as with a scholarship offer, instead of hoping the students apply on their own.

At 1215, the psychometric profile of the target may be presented, and at 1220, a clone psychometric profile and behavioral insights may be generated. In some aspects, at 1225, adjustment of the clone psychometric profile may be prompted. For example, the target may be lacking a soft skill needed for a new position or the target may have needed improvement in his ability to manage a team. This may allow a user to refine some of the characteristics for the clone.

At 1230, a candidate pool may be accessed. At 1235, candidate psychometric profiles may be compared to the clone psychometric profiles, and at 1240, candidate psychometric profiles that are similar to the clone psychometric profiles may be identified. At 1245, the identified candidates may be presented. In some embodiments, the eligible candidates may be filtered, such as based on location, technical skills, experience, interests, or other factors, as non-limiting examples. In some implementations, the eligible candidates may be ranked based on their similarity to the clone.

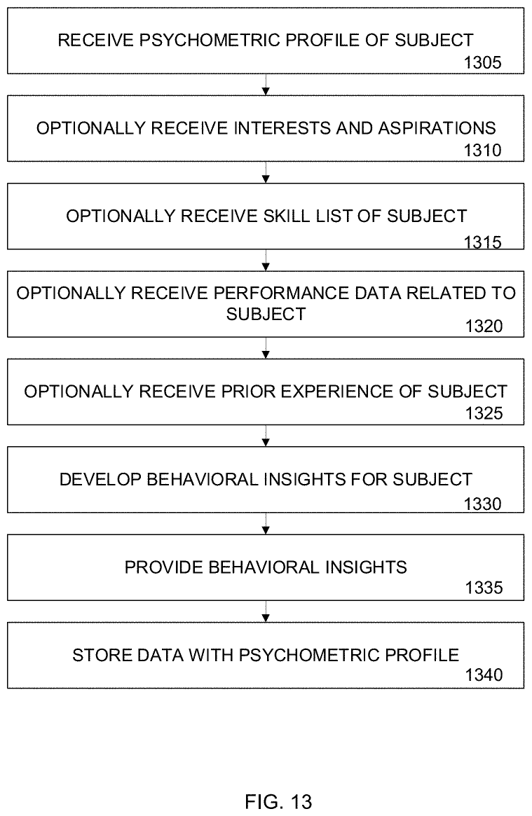

Referring now to FIG. 13, exemplary method steps for developing behavioral insights are illustrated. At 1305, a psychometric profile of a subject may be received. In some aspects, at 1310, interests and aspirations of the subject may be received. In some embodiments, at 1315, a skill list of the subject may be received. In some embodiments, at 1320, performance data related to a subject may be received. In some implementations, at 1325, prior experience of the subject may be received. At 1330, behavioral insights of the subject may be developed. At 1335, behavioral insights may be provided, such as to the subject, a manager, or employers, as non-limiting examples. At 1340, the collected data may be stored with psychometric profile.

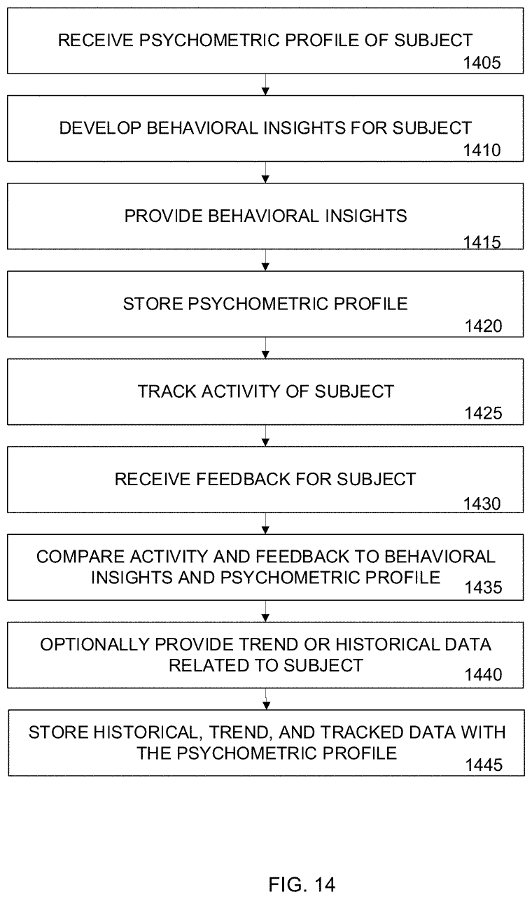

Referring now to FIG. 14, exemplary method steps for tracking performance in context of behavioral insights are illustrated. At 1405, a psychometric profile of a subject may be received. At 1410, behavioral insights of the subject may be developed. At 1415, behavioral insights may be provided, such as through a dashboard. At 1420, the psychometric profile may be stored. At 1425, the activity of the subject may be tracked. In some aspects, at 1430, feedback for the subject may be received. At 1435, the activity and feedback may be compared to the behavioral insights and psychometric profile. In some embodiments, at 1440, trend and historical data related to the subject may be provided. At 1445, historical, trend, and tracked data related to the subject may be stored with the psychometric profile.

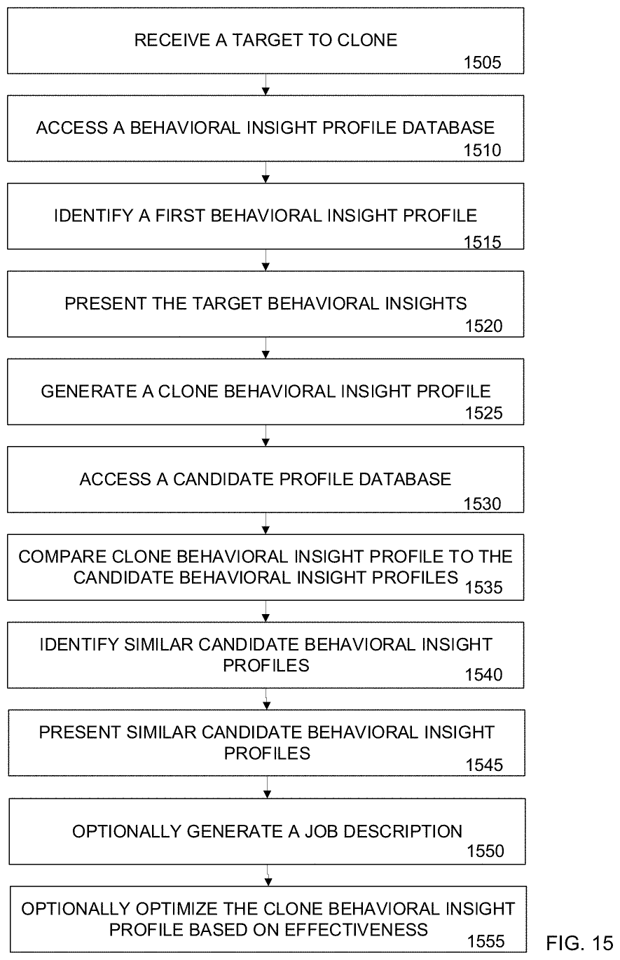

Referring now to FIG. 15, exemplary method steps for cloning behavioral insight profiles are illustrated. At 1505, a target to clone may be received. At 1510, a behavioral insight profile database may be accessed. At 1515, a target behavioral insight profile may be identified. At 1520, the target behavioral insight profile may be presented. At 1525, a clone behavioral insight profile may be generated. In some embodiments, the clone behavioral insight profile may be configurable, such as manually. At 1530, a candidate profile database may be accessed. At 1535, clone behavioral insight profile may be compared to candidate behavioral insight profiles. At 1540, similar candidate behavioral insight profiles may be identified.

In some aspects, behavioral insight profiles may comprise insights for a plurality of qualities. In some embodiments, the qualities may be weighted, wherein similarity is based on a weighted comparison. In some implementations, the qualities may be prioritized or removed, as preferred. In some aspects, the prioritization may be manually received or may be based on how the qualities affect effectiveness for a target role, such as a job, a position, a team member, or a college, as non-limiting examples.

At 1545, similar candidate behavioral insight profiles may be presented. In some aspects, at 1550, a job description may be generated based on the clone behavioral insight profiles. The job description may be customized to attract candidates with similar behavioral insight profiles. In some embodiments, at 1555, the clone behavioral insight profile may be optimized or adjusted based on an effectiveness assessment.

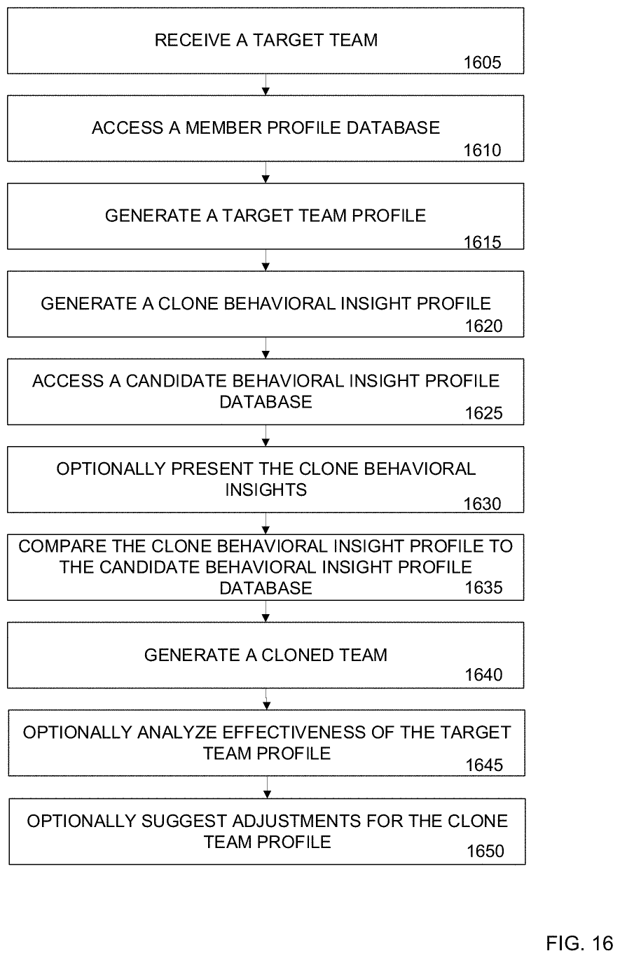

Referring now to FIG. 16, exemplary method steps for providing a cloned team are illustrated. At 1605, a target team may be received. At 1610, a member profile database may be accessed. At 1615, a target team profile may be generated. At 1620, a clone behavioral insight profile may be generated. In some aspects, original team members may be identified as less effective, wherein the clone behavioral insight profile may be adjusted to replace that profile with a more effective option.

At 1625, a candidate behavioral insight profile database. In some aspects, at 1630, clone behavioral insights may be presented. At 1635, candidate behavioral insight profiles may be compared to the clone behavioral insight database. At 1640, a cloned team may be generated, wherein the clone team may comprise a similar group profile to the clone behavioral insight profile. In some aspects, at 1645, the target team profile may be analyzed for effectiveness, and at 1650, adjustment to the clone team profile may be suggested.

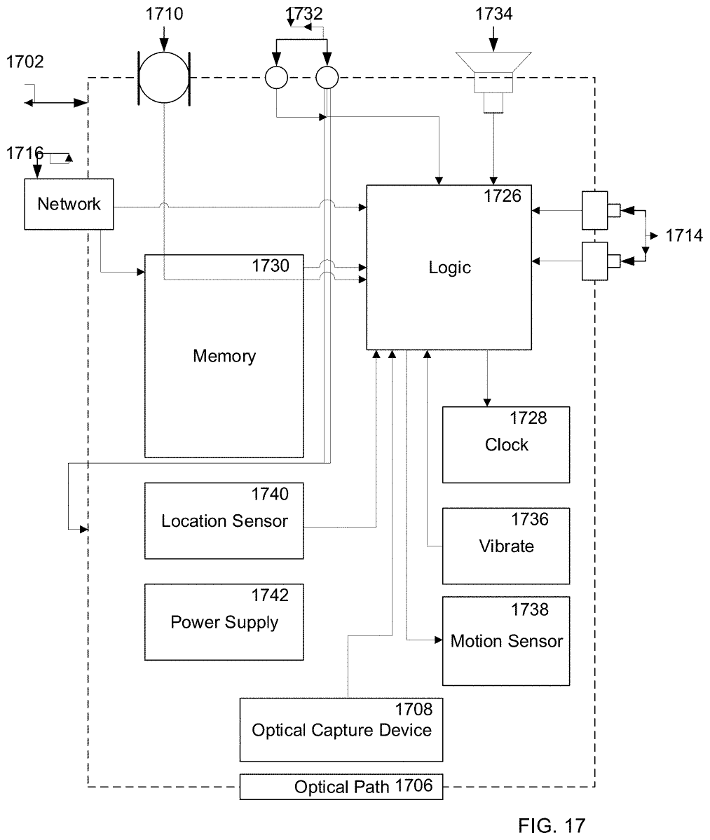

Referring now to FIG. 17, an exemplary block diagram of an exemplary embodiment of a mobile device 1702 is illustrated. The mobile device 1702 may comprise an optical capture device 1708, which may capture an image and convert it to machine-compatible data, and an optical path 1706, typically a lens, an aperture, or an image conduit to convey the image from the rendered document to the optical capture device 1708. The optical capture device 1708 may incorporate a Charge-Coupled Device (CCD), a Complementary Metal Oxide Semiconductor (CMOS) imaging device, or an optical sensor of another type.

In some embodiments, the mobile device 1702 may comprise a microphone 1710, wherein the microphone 1710 and associated circuitry may convert the sound of the environment, including spoken words, into machine-compatible signals. Input facilities 1714 may exist in the form of buttons, scroll-wheels, or other tactile sensors such as touch-pads. In some embodiments, input facilities 1714 may include a touchscreen display. Visual feedback 1732 to the user may occur through a visual display, touchscreen display, or indicator lights. Audible feedback 1734 may be transmitted through a loudspeaker or other audio transducer. Tactile feedback may be provided through a vibration module 1736.

In some aspects, the mobile device 1702 may comprise a motion sensor 1738, wherein the motion sensor 1738 and associated circuitry may convert the motion of the mobile device 1702 into machine-compatible signals. For example, the motion sensor 1738 may comprise an accelerometer, which may be used to sense measurable physical acceleration, orientation, vibration, and other movements. In some embodiments, the motion sensor 1738 may comprise a gyroscope or other device to sense different motions.

In some implementations, the mobile device 1702 may comprise a location sensor 1740, wherein the location sensor 1740 and associated circuitry may be used to determine the location of the device. The location sensor 1740 may detect Global Position System (GPS) radio signals from satellites or may also use assisted GPS where the mobile device may use a cellular network to decrease the time necessary to determine location. In some embodiments, the location sensor 1740 may use radio waves to determine the distance from known radio sources such as cellular towers to determine the location of the mobile device 1702. In some embodiments these radio signals may be used in addition to and/or in conjunction with GPS.

In some aspects, the mobile device 1702 may comprise a logic module 1726, which may place the components of the mobile device 1702 into electrical and logical communication. The electrical and logical communication may allow the components to interact. Accordingly, in some embodiments, the received signals from the components may be processed into different formats and/or interpretations to allow for the logical communication. The logic module 1726 may be operable to read and write data and program instructions stored in associated storage 1730, such as RAM, ROM, flash, or other suitable memory. In some aspects, the logic module 1726 may read a time signal from the clock unit 1728. In some embodiments, the mobile device 1702 may comprise an on-board power supply 1742. In some embodiments, the mobile device 1702 may be powered from a tethered connection to another device, such as a Universal Serial Bus (USB) connection.

In some implementations, the mobile device 1702 may comprise a network interface 1716, which may allow the mobile device 1702 to communicate and/or receive data to a network and/or an associated computing device. The network interface 1716 may provide two-way data communication. For example, the network interface 1716 may operate according to an internet protocol. As another example, the network interface 1716 may comprise a local area network (LAN) card, which may allow a data communication connection to a compatible LAN. As another example, the network interface 1716 may comprise a cellular antenna and associated circuitry, which may allow the mobile device to communicate over standard wireless data communication networks. In some implementations, the network interface 1716 may comprise a Universal Serial Bus (USB) to supply power or transmit data. In some embodiments, other wireless links known to those skilled in the art may also be implemented.

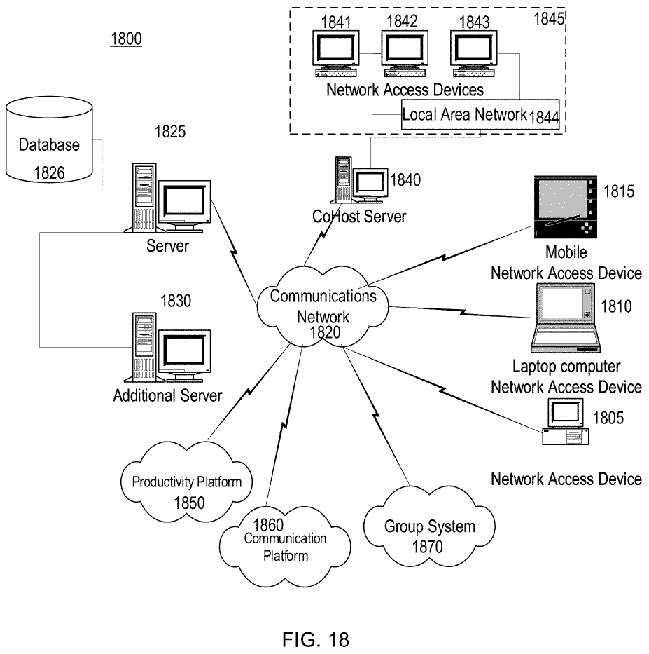

Referring now to FIG. 18, an exemplary processing and interface system 1800 is illustrated. In some aspects, access devices 1815, 1810, 1805, such as a paired portable device 1815 or laptop computer 1810 may be able to communicate with an external server 1825 though a communications network 1820. The external server 1825 may be in logical communication with a database 1826, which may comprise data related to identification information and associated profile information. In some embodiments, the server 1825 may be in logical communication with an additional server 1830, which may comprise supplemental processing capabilities.

In some aspects, the server 1825 and access devices 1805, 1810, 1815 may be able to communicate with a cohost server 1840 through a communications network 1820. The cohost server 1840 may be in logical communication with an internal network 1845 comprising network access devices 1841, 1842, 1843 and a local area network 1844. For example, the cohost server 1840 may comprise a payment service, such as PayPal or a social network, such as Facebook or LinkedIn.

In some embodiments, the behavioral insight system may integrate or communicate with external systems, such a productivity platform 1850, communication platform 1860, or group system 1870. For example, a communication platform 1860 may allow for instant messaging and provide behavioral insights in real time during communication. As another example, group systems 1870 may comprise enterprise systems, such as within companies, educational institutions, and clubs.

### CONCLUSION

A number of embodiments of the present disclosure have been described. While this specification contains many specific implementation details, these should not be construed as limitations on the scope of any disclosures or of what may be claimed, but rather as descriptions of features specific to particular embodiments of the present disclosure.

Certain features that are described in this specification in the context of separate embodiments can also be implemented in combination or in a single embodiment. Conversely, various features that are described in the context of a single embodiment can also be implemented in combination in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous.

Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order show, or sequential order, to achieve desirable results. In certain implementations, multitasking and parallel processing may be advantageous. Nevertheless, it will be understood that various modifications may be made without departing from the spirit and scope of the claimed disclosure.

What is claimed is:

1. A cloning method comprising:
receiving a first target to clone;
accessing a target behavioral insight profile database comprising a plurality of behavioral profiles, wherein each of the plurality of target behavioral insight profiles provides behavioral insights for each target;
identifying a first behavioral insight profile;
presenting the target behavioral insights;
generating a clone behavioral insight profile based on the target behavioral insight profile;
accessing a candidate profile database comprising a plurality of candidate behavioral insight profiles, wherein each of the plurality of target behavioral insight profiles provides behavioral insights for each candidate;
comparing clone behavioral insight profile to the plurality of candidate behavioral insight profiles;
identifying at least a portion of the plurality of candidate behavioral insight profiles that are similar to the clone behavioral insight profile, wherein similarity is based on predefined parameters;
presenting at least the portion of the plurality of candidate behavioral insight profiles.

2. The cloning method of claim 1, wherein the target behavioral insight profile is manually configurable.

3. The cloning method of claim 1, further comprising generating a job description based on the target behavioral insight profile.

4. The cloning method of claim 1, further comprising receiving a job description.

5. The cloning method of claim 4, further comprising analyzing the clone behavioral profile, wherein analyzing determines a level of effectiveness of the clone behavioral profile based on the job description.

6. The cloning method claim 5, further comprising suggesting changes to the target behavioral insight profile, wherein suggested changes increase the level of effectiveness based on the job description.

7. The cloning method of claim 1, wherein each of the plurality of target behavioral insight profiles and each the plurality of candidate behavioral insight profiles comprise behavioral insights for a plurality of qualities.

8. The cloning method of claim 7, wherein each of the plurality of qualities is assigned a weighted score based on predefined parameters.

9. The cloning method of claim 8, wherein similarity is based at least in part on a comparison of weighted scores of the plurality of qualities.

10. The cloning method of claim 8, wherein the weighted score is manually adjustable.

11. The cloning method of claim 8, wherein the weighted score is based on relevance of each of the plurality of qualities to effectiveness.

12. The cloning method of claim 1, wherein the target behavioral insight profile database and the candidate profile database are the same.

13. A method of cloning a team based on behavioral insights, wherein the method comprises:
receiving a target team profile comprising a target set of behavioral insights for a plurality of qualities;
generating a clone behavioral insight profile based on the target team profile;
accessing a candidate profile database comprising a plurality of candidate behavioral insight profiles, wherein each of the plurality of target behavioral insight profiles provides behavioral insights for each candidate;
comparing clone behavioral insight profile to the plurality of candidate behavioral insight profiles;
generating at least one cloned team comprising a first set of candidates, wherein collection of candidate profiles for the first set candidates is similar to the clone behavioral insight profile, and wherein similarity is based on a comparison of behavioral insight values for the plurality of qualities.

14. The cloning method of claim 13, further comprising analyzing the target team profile, wherein analyzing determines a level of effectiveness of the target team.

15. The cloning method claim 14, further comprising suggesting changes to the target team profile, wherein suggested changes increase the level of effectiveness of the target team.

16. A method of cloning a team based on behavioral insights, wherein the method comprises:
receiving a plurality of members;
accessing a member profile database comprising a plurality of member behavioral insight profiles, wherein each of the plurality of member behavioral insight profiles provides behavioral insights for each member;
retrieving behavioral insight profiles for each of the plurality of members;
generating a target team profile comprising a target set of behavioral insights for a plurality of qualities, wherein the target team profile is based on predefined parameters.

17. The method of claim 15, wherein each of the plurality of qualities is assigned a weighted score based on predefined parameters.

18. The cloning method of claim 17, wherein similarity is based at least on the weighted score of each of the predefined parameters.

19. The cloning method of claim 15, further comprising analyzing the target team profile, wherein analyzing determines a level of effectiveness of the target team.

20. The cloning method claim 19, further comprising suggesting changes to the target team profile, wherein suggested changes increase the level of effectiveness of the target team.
